(19) United States
(12) Patent Application Publication
(10) Pub. No.: US 2009/0129371 A1
(43) Pub. Date: May 21, 2009

(54) Method and system to enable mobile roaming over ip networks and local number portability

(76) Inventor: Samer Bishay, Toronto (CA)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/988,599

(22) PCT Filed: Nov. 22, 2005
(86) PCT No.: PCT/CA2005/001772

§ 371 Date: Dec. 15, 2008

Related U.S. Application Data
(60) Provisional application No. 60/697,559, filed on Jul. 11, 2005.

(51) Int. Cl. H04L 12/66

(52) U.S. Cl. 370/352

(57) ABSTRACT

A method and system for creating a virtual roaming solution for a MSISDN using a softphone over an IP network. The system involves (i) implementation of a novel virtual mobile network (VMN) comprising virtual visitor location register (vVLR), virtual home location register (vHLR) and virtual multiple switching centre (vMSC) on an IP server responsible for managing IP call traffic administration, and (ii) implementation of a novel mobile to internet gateway (MIG) comprising an VoIP gateway for diverting call traffic from the mobile network to the IP network, and an IP server with vMSC functionality to translate routing information from the VMN to GSM network so as to appear to the GSM network as a traditional mobile operator. The system dynamically registers the subscriber to the IP network, and provides valid routing information to the MSC (Mobile Switching Centre) or public telephone switch to route the call over to the NGN (next generation network) operator in the IP space.

### TECHNICAL FIELD OF THE INVENTION

This invention is related to the field of voice over internet protocol (VoIP) and mobile telecommunications, and interfaces between traditional mobile phone networks and next generation VoIP networks (NGNs).

### BACKGROUND OF THE INVENTION

Mobile or fixed wireless telephony services provide a means to transmit voice and data using radio waves from a mobile device to base station antennas, switches and the conventional public switched telephone network (PSTN), and back along the chain to the mobile or fixed wireless device. These types of wireless telephone communication can be analogue or digital. The digital mobile telephone standards are currently grouped according to the method by which bandwidth is according between mobile devices, the most popular being: time divisional multiple access (TDMA) systems, such as that offered throughout much of the world according to the Global System for Mobile Communications (GSM) standard; and code division multiple access (CDMA), exemplified by various standards from QUALCOMM or in use in Japan and Korea, and frequency divisional multiple access (FDMA) systems. Each type of device is band limited to certain frequency ranges allocated by governments. In addition to the voice services offered through the mobile telephone device, it is increasingly common for data transmission features to be enabled on these devices. A particularly common feature on digital mobile telephone devices is the Short Message Service (SMS), which forms part of current GSM standards.

One common feature of mobile telephony is that users of the service (i.e. subscribers) obtain subscriptions from mobile service providers, so that they may use the mobile telephone infrastructure to send and receive calls in association with a mobile telephone number.

Another common feature of mobile telephone devices is that the devices contain transponders to send and receive signals to and from local base station antennas and to register in the cell associated with the base station from which they receive the strongest signal. When a mobile telephone device, registered through a particular mobile service provider, is in a geographic region serviced by another mobile service provider, a protocol is used to determine how to authorize the mobile telephone device for communication and how to connect and bill for any calls, and this functionality is commonly referred to as roaming. Roaming requires both technical compatibility and an agreement between the two mobile service providers; and the cost to subscribers that is associated with roaming calls tends to be quite high. The technical details of roaming in CDMA based mobile telephone networks are different at the signalling level, but the principles at the authorization level remain the same.

Roaming pursuant to the GSM standard, being roaming by a single GSM enabled device between two GSM based mobile telephone networks, allows the convenience of a single number and a single bill.

Even within the GSM standard, there is a high transactional cost associated with roaming, as each GSM operator is required to enter into separate agreements with at least one GSM operator in a geographic region in which roaming is desired. This comes at a very high cost to subscribers since the cost of multiple international roaming agreements is ultimately passed on to them. This model also requires GSM operators to continuously update their roaming agreements as new providers come on board, leaving the consumer stranded if they travel abroad to a country where no roaming agreement is in place with the local operator. Mobile operators are continuously struggling with the complexity and high risk associated with roaming services.

Currently many roaming operators are using the Customized Applications for Mobile network Enhanced applications (CAMEL) system for authenticating calls on a Real-time basis. However, since there is revenue sharing, the price to the consumer is inflated as compared to what would be available in a competitive telecommunications market. A system which eliminates at least some of the transactional costs, without additional undue implementation costs, would provide a competitive advantage to mobile operators who employ such a system. Ideally, mobile operators could enter into an agreement with a single internet based roaming call completion clearinghouse.

The usual roaming signaling is made of the following steps, as shown in prior art FIG. 1 in relation to a GSM network:
A mobile phone or mobile station (MS), having an international mobile subscriber identity (IMSI), a mobile station integrated services digital network number (MSISDN) and a subscriber identification module (SIM) registered to a home operator, identifies base transceiver station (BTS) of a roaming operator as being the BTS with the strongest signal;
MS sends a signal to a base station (BS) via the BTS, the base station controller (BSC) and any number of BTS attached thereto making up the base station (BS),
the BS assigns a temporary mobile subscriber identity (TMSI) to the MS and provides the information to a mobile switching centre of the roaming operator (rMSC) responsible for the BS, according to a known protocol;
the rMSC requests that the visitor location register of the roaming operator responsible for this rMSC (the VLR) provide some authorization information;
the VLR creates a temporary record for the MS, and determines from the first few digits of the IMSI or from the MSISDN where to contact the home location register of the home operator (HLR);
if the roaming operator does not have a roaming agreement with the home operator, the MS is not authorized for communication;
if the roaming operator does have a roaming agreement with the home operator, the VLR uses Signaling System No. 7 (SS7) communication to provide the VLR's SS7 identification to the HLR and to request account information corresponding to the IMSI and/or MSISDN provided by the MS from the HLR, including permission to authorize the MS for roaming; and
the HLR stores the VLR information as the current location of the MS.

In the instance of a call to be received by the MS,
the PSTN checks with the HLR (if the functionality of the PSTN allows) or the MSC of the home operator (hMSC) (if the functionality of the PSTN does not) to determine the location of the MS;
the HLR identifies the VLR as the location of the MS for routing purposes,
the VLR is contacted to provide more detailed routing information and to allocate a mobile subscriber roaming number (MSRN); and
the hMSC can route the call itself, or can supply the MSRN and VLR to the PSTN for routing through some least cost preferred channel.

The IMSI is a unique non-dialable number allocated to each mobile subscriber in the GSM system that identifies the subscriber and his or her subscription within the GSM network. The IMSI resides in the Subscriber Identity Module (SIM), which is transportable across mobile phones—referred to as Mobile Station Equipment (MSE) or simply Mobile Station (MS) in the GSM standard. The IMSI is a number comprising a three digit mobile country code (MCC), a two digit Mobile Network Code (MNC), and a Mobile Subscriber Identity Number (MSIN) with up to 10 digits. Other standards use analogous serial numbers for the identification of devices and subscribers.

This protocol allows the home operator to know the location of the MS and for calls to the mobile telephone number associated with the MS to be correctly routed.

The appearance of public switched packet data networks, most notably the Internet, and the emergence of voice over Internet protocol (VoIP) as a means to route voice data over these networks creates the potential for cost and resource savings by both mobile service providers and their subscribers. Since these public switched packet data networks are primarily Internet Protocol based networks, the document refers to them generally as IP networks, without loss of generality.

There is a need for mobile service providers, also referred to as mobile operators, to be able to route calls to subscribers over the less expensive IP network. There is also a need for mobile subscribers to be able to use their mobile numbers in association with both outbound and incoming calls, even when they prefer to route the calls through the IP network or simply to a different telephone device.

There is also a need to properly account for and bill calls routed to mobile numbers connected over the IP network.

One attempt to create a mobile to internet communications regime is disclosed in the US Patent Application published under publication number US 2003/0224795 A1 by Wilhoite et al. In that solution, a full set of replica mobile user data is maintained on an IP side server which takes control of the IP side call, and appears to the existing MSC (for all intents and purposes) as a peer on the network. This configuration disclosed in that application requires a pre-configured mapping on the IP server to correctly map calls between a subscriber ID on the VoIP domain and IMSI/MSISDN in the GSM circuit switched mobile phone network. This requires a duplication of resources on the IP side. Furthermore, the Wilhoite et al. method replicates the GSM standard in a manner that could result in congestion at the HLR. According to the disclosure in the Wilhoite et al. application, multiple requests by the IP server to the HLR would be made in instances where a new IP address is assigned to the internet protocol enabled telephone device. The Wilhoite et al. application does not disclose a method to dynamically obtain a SIM serial number from an IP device.

There is a need for a system which addresses the market needs of a secure and efficient interface between mobile phone networks and VoIP networks. Such a system should preserve a subscriber's mobile identity and correctly handle local number portability (LNP) and short message service (SMS) correctly.

There is a need for a system to authorize and/or route calls to and from a VoIP enabled device using the mobile telephone network, and to correctly account for and bill such calls without undue burden on the existing mobile switching network.

### SUMMARY OF THE INVENTION

In one aspect, the invention is an improved system to permit MSISDN bound calls to be connected to an IP address comprising two devices: a mobile to internet gateway (MIG) and a virtual mobile network (VMN). The MIG performs the dual tasks of (1) voice and data traffic switching from the SS7 layer of the GSM mobile network layer to the IP network according to some VoIP standard and (2) mobile operator command translation from the IP network to the mobile network and vice versa. The VMN is a class 5 IP server with additional computer implemented functionality (either hardware or software) to emulate certain features of a roaming operator VLR and roaming operator MSC, but with automatic population of databases using data supplied from the mobile network and with the assignment of a virtual mobile subscriber roaming number (vMSRN) at the authorization stage rather than the call initiation stage.

In another aspect, the invention is a system designed to authenticate softphones with access to the Internet over the mobile telephone network by combining VoIP functionality with a novel implementation of the GSM roaming protocol. A softphone is interpreted broadly to mean any IP telephone enabled device with access to an IP network, and includes fixed access devices, or mobile telephone devices with distinct wireless internet access capabilities. The system receives authentication requests from softphone users that contain at least a serial number associated with a mobile account in packet form. In the GSM context, the softphone comprises an interface to read the IMSI, or some other unique identifier, from the SIM and transmit it to the VMN. The interface can be any type of USB SIM card reader or other types of smart card readers to connect to the softphone or even any public IP phone equipped with such reader technology. The method is an improvement on the EAP-SIM (Extensible Authentication Protocol with Subscriber Identity Module) standard currently used for authenticating mobile phone over Wi-Fi networks using SIM cards. The improvement involves internet registration over a Class 5 Server, in the VMN, and using the SS7 protocol, as translated from IP by the MIG, as opposed to Wi-Fi networks using the remote authentication dial-in user service (RADIUS). The softphone client or payphone access point will read the data from the additional SIM card provided by the home mobile operator in order to authenticate with the server using techniques and encryptions currently utilized in GSM networks, but not currently implemented in IP using class 5 soft switches.

Typically, a start message is sent by the client (IP softphone or IP payphone device) to a session initiated protocol (SIP) server, or some other VoIP server, based on the A3 algorithm of the GSM standard where the Signature Response (SRES) is calculated independently on both the MS and the network side from the Ki and a Random Number offered by the network and then compared. The MS is only registered if the responses are equal.

Parallel to the security features involving the signature response, the system identifies the correct HLR on the basis of the IMSI and communicates with the HLR via a MSC on the HLR network using the SS7 protocol. The system comprises an emulation of a MSC/VLR combination on the IP side (the VMN) with a translation device for voice traffic and command data between packet data and dedicated circuit signalling at the mobile operator (the MIG). In an optional embodiment of the system, the VMN and the MIG are implemented together as a unit at the location of a mobile operator.

Since the VMN performs the HLR query and may also perform the secure registration procedures required by the GSM standard, the system of the current invention appears as a traditional MSC, authentication centre (AUC) and VLR on the mobile operator's network. The address of the VMN appears as an SS7 address associated with the MIG. The MIG translates the commands to and from IP and sends them to and from the VMN without requiring additional functionality of the HLR or MSC of the mobile operator's network.

An improvement is that the system of the current invention assigns a vMSRN during authorization, and maps this vMSRN to future IP addresses associated with the softphone, until such time as the softphone is unauthorized. This change of procedure goes unnoticed by the HLR, but results in a reduction in the requests to update the VLR placed to the HLR.

The present invention is capable of achieving a low cost roaming solution to allow telecommunications service providers (whether mobile, fixed line, VoIP or otherwise) to allow users access to whichever wireless telecommunications protocol is available, by implementing a virtual roaming protocol compatible with the existing GSM roaming protocol. The present invention also provides means to allow preferred wireless protocols to be chosen in situations where the telecommunications service provider offers a call forward or preferred dialing rules feature.

The telecommunications service provider's users, or subscribers, thereby have the ability to use the internet as the communications media for data and voice transmission and reception, even where calls are initially directed to a traditional mobile phone number or mobile phone roaming number. Where available, and enabled by a user and the telecommunications service provider, the cost effective Internet Protocol (IP), Wi-Fi, Bluetooth or other data transmission protocols capable of Internet communications are used to handle a user's in bound and out bound calls. Similarly, where a wireless or fixed Internet connection is not available, the normal dialing rules for the user will direct calls based on the existing technology.

Traveling subscribers will be able to avoid having to use a particular local GSM telephone connection where a wireless internet connection is available, and thereby avoid having to pay fees (either directly or indirectly) to the local GSM provider.

HLRs will be able to benefit by reducing or eliminating the amount of roaming charges they pay to VLRs.

The method and system of the present invention also benefits HLRs in that they do not need to implement new or untested protocols over their existing telephone service, as the present invention emulates an existing protocol.

These advantages exist on both in bound and out bound calling for both users and the telecommunications provider supplying the service.

The invention disclosed herein is suitable for either CDMA or GSM mobile communications systems, but given the prevalence of GSM systems, the most preferred embodiments are discussed in relation to that standard. A person of skill in the art can easily adapt the technical aspects of this disclosure to the related CDMA protocols. This disclosure assumes a basic understanding of the GSM system, including the Mobile Application Part (MAP) specification and the Functional description of the ISDN user part of the Signalling System No 7 (SS7 or SS7/C7) which can be obtained from ETSI at www.etsi.org.

In a VoIP mobile roaming system comprising the MIG and the VMN, the VMN simulates the traditional MSC/VLR without the need of a separate pre-populated database. A mobile subscriber has a MS with an IMSI, but also has a softphone application, a virtual mobile station (vMS) or an integrated access device, which comprises a record of the IMSI and/or a fixed link to the SIM. Together, for convenience and without loss of generality, this document refers to all such softphones, vMS and integrated access devices capable of packet switched calls as softphones, although packet phone or IP phones are also acceptable synonyms. Authentication of a softphone over the IP network, is necessary when such a mobile subscriber first logs onto the internet using the softphone and makes a service request. Authentication comprises at least the following steps:
the softphone logs into IP network and obtains a current IP address;
the softphone sends a registration request containing the IMSI and current IP address to a predetermined VMN, where all such information (and future related information) is stored as a softphone location record;
the Virtual Mobile Network (VMN), in its most preferred embodiment, comprises a virtual Mobile Switching Centre (vMSC) being software which emulates an MSC having an IP address rather than an SS7 address, and a virtual Visitor Location Register (vVLR) being software which emulates a VLR having either the same or a different IP address, the vVLR is the component which creates the temporary record for the softphone (the softphone location record noted above) and communicates with the HLR based on a MAP protocol number for the HLR derived from the IMSI;
communication from the vVLR to the HLR is translated by the MIG from packet commands to SS7 signalled commands.
the MIG, in its most preferred embodiment, comprises an IP server, a SIP to SS7 converter, is identified by at least one unique SS7 address, and is typically proximate to the HLR associated with the IMSI;
the HLR recognizes the vVLR as a VLR and returns the database record associated with the subscriber account for the IMSI;
the VMN analyses the database record to determine whether the mobile subscriber account is entitled to the IP roaming services;
if the mobile subscriber is not so entitled, the registration request is denied;
if the mobile subscriber is so entitled, the VMN takes the following action.
   adds the database record from the HLR to the temporary record for the softphone in the vVLR;
   creates a virtual Mobile Subscriber Roaming Number (vMSRN);
   notifies the softphone that it is authorized for communication via the mobile telephone network.

During interrogation of the HLR when a call to the MSISDN associated with the same IMSI is being set up, the HLR is able to request a MSRN and MSC from the vVLR for routing purposes. In fact, the vVLR returns the vMSRN and vMSC which are in a compatible format satisfactory to the HLR. The vMSC has an actual address of the MIG. The vVLR then maps the vMSRN to the IP address of the softphone also stored in the temporary softphone location record.

Since the VoIP gateway component of the MIG is connected to the IP network, it is able to exchange packet-based telephone calls with the vMS over the IP network using known protocols, such as H.323, session initiated protocol (SIP) or media gateway control protocol (MGCP) or others.

Actual roaming rules at the HLR or at the operational level within the mobile service provider can determine when to permit IP roaming. The system of the immediate invention is implemented using HLR identification and authentication rules that do not require a pre-existing subscriber database, and is therefore an improvement over the method disclosed in Wilhoite et al. The MIG can be implemented as a plug in to the existing GSM architecture model without additional database configuration or set up without any loss of the desired benefits.

It is a solution which exhibits seamless integration at the MSC layer, and overcomes the additional integration costs that is otherwise associated with a traditional mobile roaming service provider having to implement or fit non-standard equipment or protocols into its network.

In a further embodiment of the invention, the VMN also comprises a virtual home location register (vHLR) for subscribers to the networks of one or more Mobile Operators, to permit global local number portability. The vHLR acts as a mirror of the data contained in the HLRs of all of a subscriber's local accounts in different jurisdictions, and links these accounts internally so that the preferred vMSRN or MSRN (as the case may be) currently authenticated and active on the network is passed to the appropriate switching centre for call completion. The only preconditions are that each of subscriber's mobile operators must enter into an agreement with the VMN operator. The VMN can act as a clearinghouse for all calls destined for an MSISDN, even if they are notionally forwarded to another device; and even if that device is connected over the IP network. This creates an administrative savings, as each mobile operator only needs a single agreement with the VMN operator which allows intercommunication with all other mobile operators similarly engaged.

### BRIEF DESCRIPTION OF THE DRAWINGS

FIG. 1 is a block diagram for the existing roaming system architecture.

FIG. 2 is a block diagram implementation of the MIG and the VMN in one embodiment of the invention.

FIG. 3 is a block diagram depicting call connection to or from mobile devices over the IP network in accordance with one embodiment of the current invention.

FIG. 4 is a block diagram of the steps required to authenticate a virtual Mobile Station (vMS) or softphone connected to the system of the current invention over the IP network using an IMSI associated with an existing mobile station.

FIG. 5 is a block diagram depicting billing, call handoff and local number portability implemented according to the immediate invention.

### DETAILED DESCRIPTION OF THE INVENTION

A detailed description of the embodiments of the invention will now be provided with specific reference to the drawings illustrating preferred embodiments of the invention.

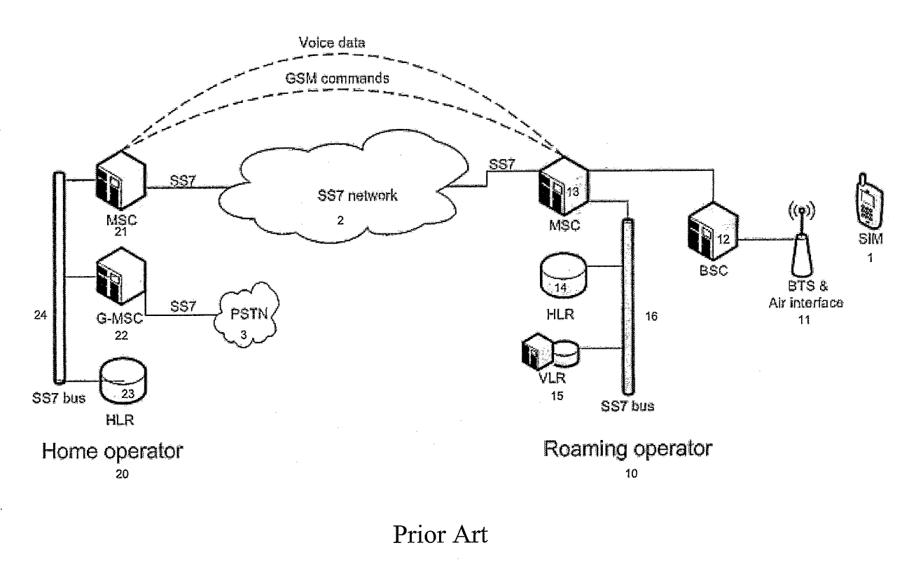

FIG. 1 depicts a typical roaming scenario between a home operator GSM network, 20, and a roaming operator GSM network, 10, in which a mobile device, 1, (referred to as a mobile station (MS) in GSM parlance) is authorized for communication. MS, 1, comprises a Subscriber Identification Module (SIM) with at least one International Mobile Subscriber Identifier (IMSI) and at least one dialable mobile phone number (MSISDN) registered through the home operator's network, 20. MS, 1, communicates with a base transceiver station (BTS), 11, by radio communication over the air interface within the roaming operator's network, 10. Many BTS, 11, may be connected to a base station controller (BSC), 12. In turn, many BSC, 12, may be connected to a mobile switching centre (MSC), 13. Typically, one home location register (HLR), 14, is associated with the roaming operator's network, 10, and a separate HLR, 23, is associated with the home operator's network, 20. In the current example, a record (not shown) having the IMSI and MSISDN numbers associated with the SIM of MS, 1, is stored in the home operator's HLR, 23, with additional subscriber related information including roaming authorizations Administrative, location, and authentication commands are communicated between the roaming operator's MSC, 13, and the home operator's MSC, 21. In particular, a visitor location register (VLR), 15, associated with the MSC, 13, is a database containing a temporary record of all mobile devices within its region of control (which may include more than one MSC). The VLR, 15, communicates with the HLR, 23, via roaming operator's Signaling System No. 7 (SS7) bus, 16, MSC, 13, SS7 network, 2, and home operator's SS7 bus, 24, to obtain the record for MS, 1. By the same channels, the VLR, 15, communicates addresses and mobile subscriber roaming numbers (MSRN) to the HLR, 23, to allow proper routing of future calls to MS, 1, which may originate at gateway mobile switching station (G-MSC), 22, from the public switched telephone network (PSTN), 3.

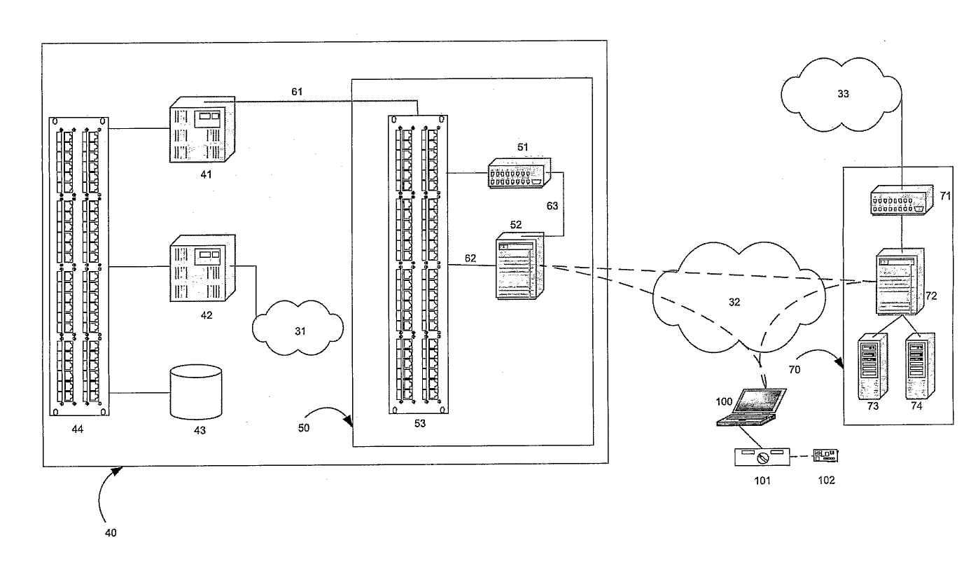

FIG. 2 depicts the architecture of the immediate invention which connects calls destined for a MSISDN to an internet protocol softphone, 100, connected to the Internet network, 32. The system is analogous to that shown is FIG. 1, but with some improvements which permit mobile telephone numbers to be used by softphones. In the embodiment shown, a softphone, 100, is connected to a SIM, 102, by a SIM Card Reader, 101. The softphone, 100, is also connected to an IP network, 32, by any available means. Over the IP network, 32, the softphone, 100, is able to communicate with either an emulation of an MSC/VLR residing on a VoIP base station server, referred to as a virtual mobile network (VMN), 70, or the Mobile to Internet Gateway (MIG), 50. The VMN, 70, is the main controller of the VoIP operations, and it contains a Class 5 server solution, and control software, which preferably includes an emulation of an MSC which permits roaming (the virtual MSC or vMSC), 73, and an emulation of the visitor location register (the virtual visitor location register or vVLR), 74. The VMN, 70, is possibly connected to other non-mobile telephone networks, 33, through a hardware interface (possibly SIP to SS7), 71, for routing other-than-to-home calls of a mobile account associated with the SIM, 102. The MIG, 50, is preferably installed on the GSM home operator's, 40, premises but this is not required, so long as an SS7 connection, 61, exists between the MIG, 50, and an MSC, 41, of the home operator, 40. The MIG, 50, comprises a VoIP gateway (possibly SIP-SS7), 51, controlled by an IP server, 52, which emulates the basic functionality of an MSC and is connected by a network connection, 53, which is an SS7/C7 pipe in the embodiment shown. The IP server, 52, may be connected to the SS7/C7 pipe, 53, directly by connection 62 or through the VoIP gateway, 52, by connection 63. Optionally, the security and reporting features of the VMN, 70, may be resident on the IP Server, 52, instead, however, this would not be ideal for sharing functionality between different mobile operators. In the GSM environment, roaming and billing signalling are emulated according to the MAP protocol. An SS7 connection, 61, allows communication between the MIG, 50, and the Mobile Switching Centre (MSC), 41, of the home operator, 40, over the home operator's SS7/C7 bus, 53. Practically, the IP server, 52, performs the command control signalling while the VoIP gateway, 51, performs the voice and data traffic transmission.

Also at the home operator network is a home location register (HLR), 43, and a gateway mobile switching centre (G-MSC), 42, connected to the Public Switched Telephone Network (PSTN), 31.

Since the solution (i) connects to the home operator by means of an SS7 link, 61, (ii) has a normal SS7 address, and (iii) acts as any other GSM operator; the home operator's, 40, hardware cannot differentiate between the simulated MSC/VLR in the VMN, 70, and a MSC/VLR belonging to any other GSM operator.

The softphone, 100, optionally employs the session initiation protocol (SIP) to connect to the VMN, 70, for authentication or the MIG, 50, to exchange voice and data packets. To authorize as an active mobile subscriber on the mobile network or receive SMS messages, the softphone, 100, must provide an IP address to the VMN, 70, which creates a mapping to a virtual mobile subscriber roaming number (vMSRN). Once authorized, communication to the softphone, 100, is directed first to the MIG, 50, on the basis of the vMSRN, and then the MIG, 50, is able to translate the vMSRN to a current IP address by virtue of the data record stored in the vVLR, 74.

The following steps are taken by the software residing on the softphone, 100, VMN, 70, or MIG, 50, at the start of roaming:
The user starts the softphone, 100, which obtains mobile subscriber data off the SIM 102 using the SIM reader 100, and the softphone logs on the existing Class 5 server 72 on the VMN, 70, (which may even be the IP server 52 in the MIG 50);
on the basis of the transmitted mobile subscriber data (normally MSISDN and/or IMSI), the VMN 70 determines which mobile operator is responsible (in this example the home operator 40) and contacts the HLR, 43, of such home operator 40 via MIG 50;
The MIG 50 creates a partially packet-switched partially dedicated link connection between the vVLR 74 of the VMN 70 to the HLR 43 of home operator 40, to allow the roaming dialogue;
When the discussion is over, the VMN 70 responds back to softphone 100, that service is either enabled or denied.

The following steps are taken by the software at the conclusion of a roaming session:
The MIG, 50, receives information from the MSC, 41, that the mobile account has a new location with another VLR (MSC automatically informs the previous roaming partner when it initiates the dialogue with another operator);
the MIG connects to the VMN to inform that the specified user is no longer roaming in the IP network; and
the VMN 70 commands the IP server 72 to logout the user.

Since each call comprises a signalling path and a media path a traffic bottle neck occurs in the mobile operator's circuit-switched communication network. The method of the current invention off-loads this bottle neck from the operator's circuit-switched network to the IP network—access to which is in abundance at most of mobile operator facilities at a much lower cost per port than a traditional circuit-switch. Also, the media path would be routed directly to the subscriber from VoIP gateway 51 without having to pass through the VMN 70 where all the core components on the internet cloud are located. This keeps the bandwidth consumption at a minimum and minimizes latency by using the inherent internet characteristics that already optimize communications by taking optimum and reliable paths between backbone networks. The method of the immediate invention achieves the implementation goals of reducing network bottle necks and reducing the consumption of limited resources at operator's facilities. This, in turn, helps achieve the collateral goal of reducing the associated costs and charges to subscribers.

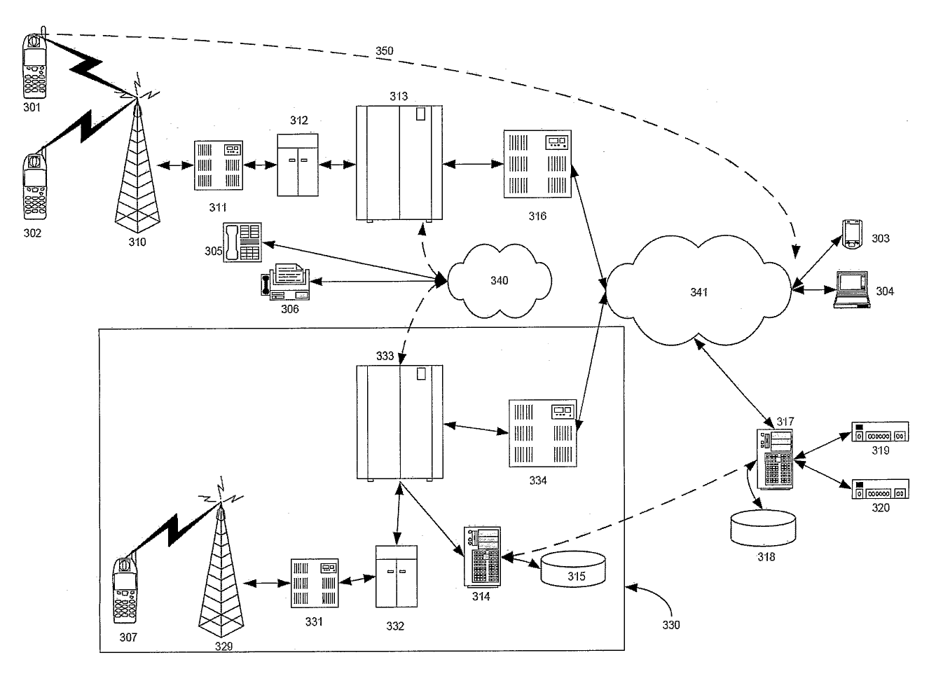

FIG. 3 depicts a roaming scenario, where a range of communications devices on a network are capable of communication over a variety of channels. Mobile devices, 301 and 302, are roaming within telecommunications range of a mobile radio tower, 310, connected to a MSC, 313, via a BTS, 311, and a BSC, 312, all operated by some GSM operator other than their home operator, 330. The MSC, 313, is able to communicate with a MIG, 316, using a number of time division multiple access protocols, depending on the purpose and type of communication, which include SS7 or its C7 counterpart. The MIG, 316, can communicate over the IP network, 341, using either the SIP or H323 protocols. Any number of personal communications devices, 303, or personal computers, 304, may have access to the IP network, 341, using known methods. The mobile device, 301, may also have access to the IP network, 341, over a secondary channel, 350. When connected through the radio tower, 310, the location of each of mobile devices 301 and 302 are stored in the visitor location register of MSC, 313, and also in the home location register of GSM home operator, 330, typically stored at one of its MSC, 333.

Calls may be placed to the mobile device, 301, may come from any number of sources, including the mobile device, 302, on a roaming network, traditional telephones, 305, or faxes, 306, connected to the traditional PSTN, 340, or from other mobile phone, 307, authorized at the GSM home operator, 330. In each instance, the call is directed to an MSISDN associated with the mobile device, 301, and the PSTN, 340, MSC, 313, or MSC, 333, contact the HLR at MSC, 333, to determine the VLR which has most recently registered the location of the mobile device, 301. Where the most recent VLR is that associated with MSC, 313, the call is directed in the usual way. However, according to the current invention, the mobile device, 301, or any of the devices 303 or 304 with access to the SIM of the mobile device, 301, may register a current location via the IP domain, as discussed above, using VMN, 317, having a billing records database, 318, an emulation of VLR functionality (vVLR), 319, and an emulation of MSC functionality (vVLR), 320. The roaming module will permit the authentication protocol where the user has logged in to the IP network, 341, and where a valid and activated VoIP roaming subscription is in place.

If the subscriber is not currently on the network for any reason, such as internet unavailability, temporary loss of internet connection or is simply not logged into the network, the call would be routed the traditional way. In one embodiment of the current invention, SMS messages can be transmitted over the existing SS7/C7 links and held for the subscriber in a caching facility.

The following steps outline calling the roaming user currently registered to an IP address via the VMN:
The GSM home operator 330 gets the call;
The MSC 333 queries the HLR and gets the SS7 code of the VLR, which is currently the SS7 address of MIG 334;
The MSC queries the vVLR 319 at the VMN 317 via the MIG 334 for a temp MSRN;
The vVLR 319 responds via the MIG 334 with the vMSRN assigned when the SIM of the mobile device in question was authorized for roaming.
The GSM operator 330 routes the call through an emulated MSC at the MIG 334 using the vMSRN.
The emulated MSC at the MIG 334 queries the virtual VLR using the vMSRN to determine the most recent IP address for routing, and uses this to complete the call to the softphone associated with the SIM over the IP network.
The VMN 317 maintains call billing data in the billing register 318, and sends the relevant information to the billing database 315 of the home operator in the form of a call detail record (CDR). Typically, this final communication is sent to the CDR Mediation Server 314.

In order to route calls through the home operator network, the home operator needs an interconnection to the MIG. This is typically through the assignment of an SS7 point code/address by the home operator. If the MIG is controlled by the home operator, no agreement is required. If the MIG is controlled by a next generation VoIP network (NGN) or other third party provider, the NGN or third party provider must enter into a roaming agreement with the home operator.

It may be desirable for the softphone user to direct a call through the home operator network. One reason may be to take advantage of pre-purchased call minutes, or free calling to another mobile subscriber on the same network. The steps to connect such a call are as follows:
The mobile user starts the client software, logs on, and is authenticated (see above).
The VMN 317 manages the call and directs the client software to connect with a MIG 334 proximate to a home operator 330.
The MIG 334 routes the call through the MSC 333, which appears for all intents and purposes as a regular mobile call from another local MSC.
The VMN 317 collects the CDR and stores it in the billing database.
At some point after the call the VMN 317 either instructs the MIG 334 to send the CDR to the MSC 333 of the home operator 330 using MAP protocol over the SS7 channel in real time, or sends the CDR to the CDR Meditation Server 314 itself over the IP network.

The VMN 317 is able to route other calls according to normal VoIP routing preferences. In such instances, the home operator's mobile network is never used, but the VMN is optionally permitted to send the billing info to the home operator's network if home operator is responsible for billing.

At the end of every call, the VMN emulates a billing database 318 of a roaming operator and sends CDR and/or call event detail (CED) for billing purposes to the home operator 330 as if it were a standard MSC.

The VMN is optionally able to temporarily disable a user, during the period between user login to the VoIP network with a SIM and a response back from the home operator on whether the SIM is to be authorized for this type of roaming.

The VMN is optionally able to provide CDR and/or CED info by (1) file transfer, web services, database access, or (2) through real time access, or is able to instruct the MIG to send the CDR and/or CED in either of those ways.

The SS7/C7 signalling equipment that is at the home operator's cloud, allows the implementation of all the GSM mobile services such as SMS via the MIG, since the SS7 signaling does not differentiate the MIG from circuit switched elements on the GSM network. In this scenario, the extensive IP network is utilized fully for a complete solution which is transparent to the subscriber by offering a true roaming environment with the flexibility to roam on other mobile operator's networks freely.

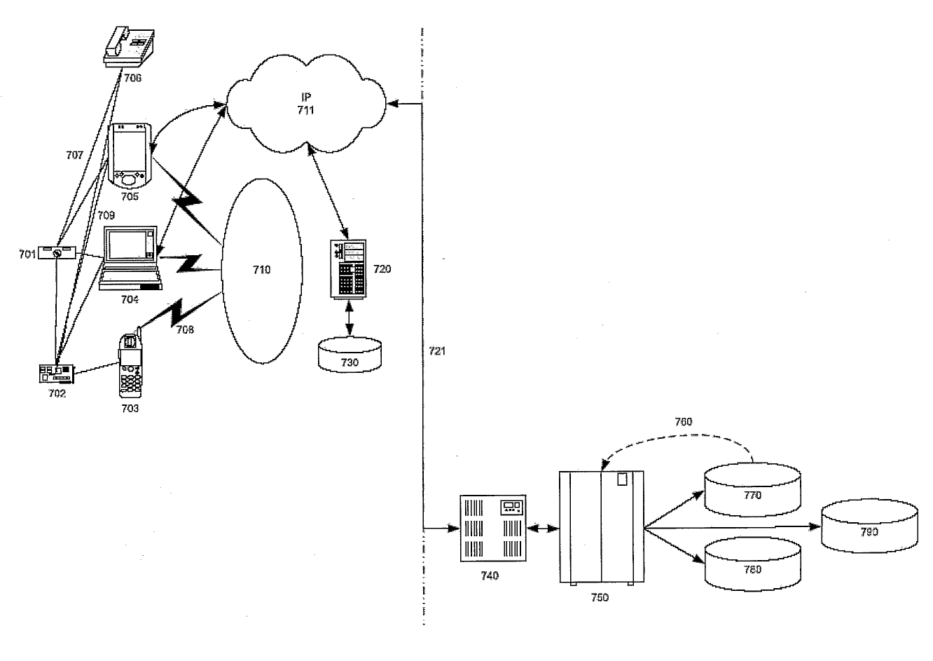

FIG. 4 shows, in greater detail, some possible embodiments of the capture of the SIM Card 702 on the IP side of 721 for security purposes, and the transfer of identification data from the VMN IP Server, 720, to the appropriate registers of the MSC, 750.

To implement the security protocol: either the mobile device 703 itself is able to read the SIM Card 702, or any of the IP softphone enabled devices 704, 705 or 706 can rely on an internal or external SIM Reader 701 to extract the necessary data. Typically, the necessary data is the IMSI. The IMSI is transmitted by the device at issue to the VMN 720, either directly over the IP network 711, or over the IP network 711 via a radio frequency connection 710. Typical radio frequency connections include Bluetooth, infrared- or other wireless access standards. The VMN 720 must be able to handle requests to the Authentication Center (AUC) of the GSM network switching subsystem for the invention to function independently in GSM. The vVLR 730 identifies the HLR 780 as the home location register of the SIM on the basis of the IMSI, or perhaps on the basis of the MSISDN number and the Personal Unblocking Key (PUK) if the IMSI is corrupted or unavailable. During the request to the HLR 780 for authentication, the AUC 770 generates a random number as a challenge 760 to the SIM 702. The SIM 702 responds to the challenge by combining the Ki of the SIM Card 702 with the random number according to the A3 algorithm to generate a signature response (SRES) unique to the SIM Card 702. The SRES is returned to the AUC 770, which contains the only other copy of Ki for verification. An optional final check could be made to the EIR register for blacklisted stolen mobile devices. Further encryption using the cipher keys (Kc) for traffic is not needed, since the IP traffic can be encrypted using specific tunneling software between the softphone and the MIG 740 sitting on home operator's SS7 network. Optionally, the Extensible Authentication Protocol (EAP-SIM) can also be used, with the challenges being used to create a 64-bit Kc which acts as a longer session key.

In instances where the IMSI is not available, and the AUC challenges for Ki not used, the PUK and MSISDN can be used to perform limited authentication. In such instances, the VMN creates a Temporary IMSI (TMSI) which is used for the communication with the virtual subscriber, so that the confidential IMSI is never improperly passed.

Call Detail Records (CDRS) are produced every time a user makes a call or sends a text message. The CDRs are produced in the MSC where the call or message originates. CDRs are then gathered in a centralized database and used for billing and other purposes.

In the GSM standard, each CDR contains the following information:
Originating MSISDN (A-Number),
Terminating MSISDN (B-Number),
Originating and terminating international mobile equipment identity (IMEI),
Length,
Type of Service, and
Initial serving Base Station (BTS) (not subsequent BTSs after handover)

According to known methods on the GSM side, CDRs can be filtered on any of the above parameters. This means that one can not only obtain a list of all calls made to/from a certain SIM, but also to/from a certain phone, regardless of which SIM was used. By looking at the serving BTS, the location of the subscriber can be pinpointed to the accuracy of a cell at any time the subscribers sends or receives a call or a text message. The CDRs are an integral part of the GSM system, and it is an important improvement that the system of the immediate invention handles the billing records in an efficient way which interfaces correctly with both VoIP and GSM standards and conventional way. Important to this implementation in the context of inbound calls to the softphone is assigning the terminating MSISDN, terminating IMEI, type of service and initial serving BTS in a manner that is meaningful to the VoIP provider and at least not confusing to the GSM standard. Within the GSM network, higher application layers need to be able to correctly parse and assign mobile to IP network calls. This is only possible if the CDR is correctly formatted in a manner which does not duplicate previously assigned GSM codes for the various parameters. One method to uniquely identify IP side devices in the CDR is to use the unique medium access control (MAC) address of the IP device as part of the IMEI according to a rule which does not cause duplication with the IMEI number system.

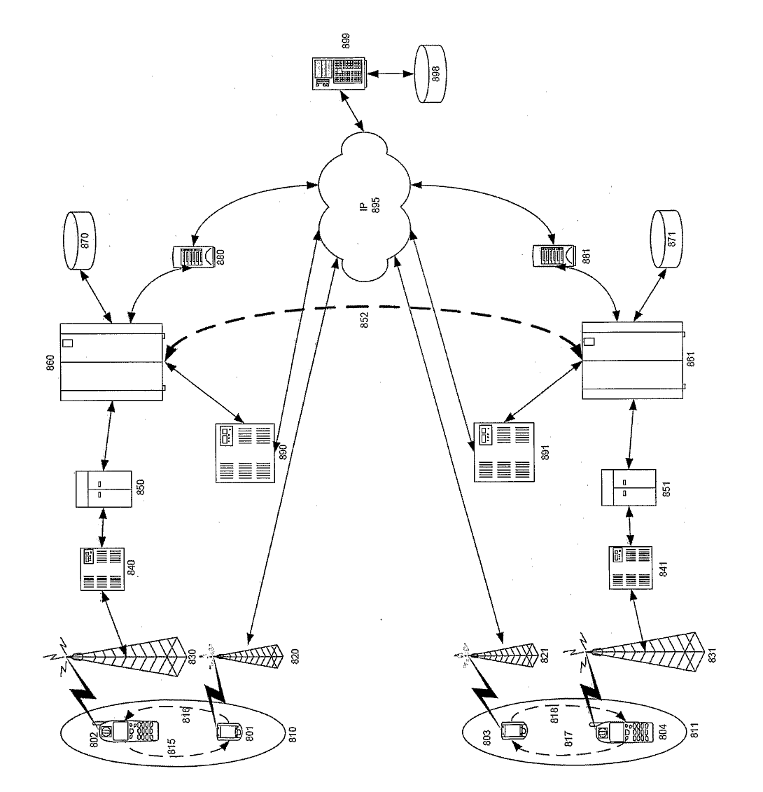

FIG. 5 depicts a range of communications scenarios employing an embodiment of the current invention, and demonstrates how an IP server equipped with the VMN functionality of the current invention, 899, may be deployed to create a global local number portability (LNP) database, 898, and otherwise manage calls. The VMN, 899, has the emulated MSC and VLR functionality of a MIG with additional functionality of an emulated home location register for global LNP numbers (vHLR). A mobile device 802 with GSM capability and an associated IP softphone 801 are within the connectivity region 810 of Mobile Operator A. Devices within 810 may communicate with a GSM network radio frequency tower, 830, or a wireless IP antenna, 820. The mobile device 802 and the IP softphone 801 include some GSM network to IP network handoff rule, 815, and some IP network to GSM network handoff rule, 816, and each is associated with a GSM account using the same internal SIM (not shown) for mobile roaming authentication. The network of Mobile Network Operator A also includes BTS 840, BSC 850, MSC 860, HLR/VLR unit 870, CDR Mediation Server 880, and MIG 890. Using protocols discussed above, the IP antenna 820, CDR Mediation Server 880 and MIG 890 have access to the IP network 895, over which packets are transferred on the basis of, inter alia, IP addressing.

Similarly, mobile device 804 and IP softphone 803 are within the connectivity region 811 of Mobile Network Operator B, may have either the ability to communicate with a GSM network base station tower, 831, or a wireless IP antenna, 821. Mobile device 804 and IP softphone 803 include some GSM network to IP network handoff rule, 817, and some IP network to GSM network handoff rule, 818, which may be the same or different from the rules 815 and 816. These devices also operate over a single SIM number for mobile roaming authentication. The network of Mobile Network Operator B also includes BTS 841, BSC 851, MSC 861, HLR/VLR unit 871, CDR Mediation Server 881, and MIG 891, and is similarly connect to the IP network 895.

Where a roaming agreement exists between Mobile Network Operator A and Mobile Network Operator B, calls to or from mobile station 810 registered through Mobile Network Operator B but within the footprint of Mobile Network Operator A, can be assigned roaming numbers over a traditional MSC to MSC connection, 852. However, where no such agreement is exists, the calls cannot currently be connected. Further, where both mobile stations 810 and 811 are registered to the same subscriber, there is currently no uniform rule to dynamically route calls to such subscriber. According to the immediate invention, the Mobile Operators A and B only need an agreement with the operator of transit IP server 899. The transit IP server 899 acts as a virtual home location register (vHLR) and a vVLR for all subscribers to the enhanced system. The subscriber, based on any MSISDN numbers associated with subscribers accounts, is considered to have the vHLR as the home location register for all accounts. Authorization requests by all devices are fielded by the vHLR and are also passed to the actual HLR as if the transit IP server 899 was a VLR. The vHLR contains records for all registered devices, and through an emulation of the HLR rules for each of them, is able to decide which devices are active and which of the active devices are preferred. This preferred routing information is shared with the HLR/VLR units 870 and 871 as necessary. When a call connection request to the subscriber is initiated, the receiving VLR is able to provide a vMSRN for a totally different device, and to generate the correct billing information for each device.

FIG. 5 also illustrates how this network can grow into a smart local number portability (LNP) global database. A subscriber with mobile device 804 and IP softphone 803, say Subscriber B, is on a roaming network, in a foreign jurisdiction, but desires to appear to have a local presence in the home operator network of Mobile Operator A, including an E164 number (MSISDN) with Mobile Operator A. Another subscriber with mobile device 802, say Subscriber A, local to the home operator can dial the local E164 number for Subscriber B. The home operator is able to bill Subscriber A for a local call, according to the usual methods, and also forward the call to Subscriber B, using the method of the current invention. If Subscriber B is connected using IP softphone 803 over the IP antenna 821, this method of the invention alleviates the costs associated with the trunk of the foreign roaming operator, Mobile Operator B, at MSC 861. Further, an unlimited number of MSISDN numbers can be associated with a subscriber record held in the LNP database at the VMN, 899. The process of locating Subscriber B on a softphone or on another E164 number somewhere else globally can simply be automated by having an LNP database that is automatically updated to route the call to the IP soft phone if user is logged into the IP network through one of the IP access devices. If Subscriber is not logged in and has turned on unconditional IP Roaming, then LNP database would automatically return the Local Routing Number (LRN) of the associated switch in order for the call to be completed to the destination country. This of course assumes that the subscriber has signed up to this service and has informed the home operator or the MIG operator (if different from the home operator) of his other E164 numbers. The LRN number returned back to the soft switch would be the number associated with the MIG in the home country and call would be completed instantaneously via the IP network to subscriber for minimal fees.

Routing for subscribers registered to different MSC's can also be optimized by the following method which takes advantage of the lower cost of transmission over the packet based IP network as opposed to the dedicated circuit network. A Subscriber registered to Mobile Operator A has moved from the range 810 of radio tower 830 into range 811 of radio tower 831 in the network of Mobile Operator B, and a location update message is sent to the HLR/VLR 871 acting as VLR which generates a TMSI and a LAI according to GSM rules sends it to either the vHLR/vVLR unit in the VMN 899 or the HLR/VLR unit 870 acting as HLR. The location update message contains a MSRN assigned to the subscriber by the VLR 871. If the subscriber is entitled to service, the VMN 899 or the HLR 870 sends a subset of the subscriber information to the new VLR 871 and sends a message to the VLR 870 to unregister the location. An additional improvement is each of Mobile Operator A and Mobile Operator B have set their respective MIG 890 and MIG 891 as the first in route preferred choice instead of the traditional dedicated circuit 852. The decision on whether IP routing of the mobile call is possible is made by transit IP server 899, which, in this embodiment, comprises a database of information about IP enabled local routing options at each MSC (preferably the local MIG). If the MSC address matches an IP serviceable area then the transit IP server 899 advises that a call from mobile device 802, for instance, should be routed from MSC 860 to MIG 891 through MIG 890 instead of directly to MSC 860 over high cost dedicated circuit link 852.

The steps to achieve the low cost routing comprise:
Mobile Network Operator A MSC 860 sends a least cost routing table option of MIG 890 as a preferred choice to (instead of traditional 852 link)
MIG 890 polls VMN 899 as to whether a recipient MIG is available based on such other MIGs VLR SS7 address or the MSRN of the call.
VMN 899 will either accept or deny the request based on availability of MIG 891 on Mobile Network Operator B's network.
If available then call is routed from MIG 890 to MIG 891 over the IP network. if not available then call is routed through traditional dedicated circuits 852 I

To avoid problems in billing any of the above calls, such as where transit IP server 899 is not owned by the billing operator or where Operator A and Operator B do not have roaming agreements, CDR records are transmitted from either of CDR Mediation Servers 880 or 881 to the transit IP server 899 where they are collected in the central billing database 898, and from where they are transmitted to the appropriate CDR Mediation Servers 880 or 881.

Billing a call from mobile device 802 to mobile device 804 where the voice traffic is passed over the IP network 895 instead of the dedicated circuit line 852 involves 5 legs: a first leg from mobile device 802 to MSC 860; a second leg from MSC 860 to MSC 890, which is normally internal to the Mobile Operator A's network; a third leg from MIG 890 to MIG 891, which avoids the MSC 860 to MSC 861 connection over the traditional network 852; a fourth leg from MIG 891 to MSC 861, which is internal to Mobile Operator B's network; and a fifth leg from MSC 861 to mobile 804.

There are at least three scenarios for which this call may be billed in accordance with the immediate invention. First, mobile device 802 is calling mobile device 804 at an MSISDN number issued by Mobile Operator B. As an outbound call from mobile device 802, the first and fifth legs are billed and reported in the traditional way. Each of Mobile Operator A and B will decide how to bill the second and fourth legs to their respective MSCs and MIGs. The VMN is involved to the extent it handles the third leg between MIG 890 and MIG 891, and the cost of this leg is reported to Mobile Operator A for billing to mobile device 802 and Mobile Operator B for billing to mobile device 804.

In the second scenario, mobile device 802 is calling mobile device 804 at an MSISDN number issued by Mobile Operator A, and mobile device 804 is roaming. Mobile device 802 is billed for a local call for the first leg, mobile device 804 is billed for the second, third, fourth and fifth legs. Billing can occur in one of two ways, VMN 899 operator reports the cost of the third leg to Mobile Operator B, which bundles the bills and reports the charges to Mobile Operator A. Or, Mobile Operator A can report the charges to VMN 899, which stores the data in the billing database 898, and which acts as a clearinghouse for reporting the charges back to mobile device 804. Preferably, VMN 899 has also preformed the authentication and handled the call routing details between the MIGs 890 and 891.

The third scenario is a most preferred embodiment of the invention. Mobile device 802 is calling a subscriber who owns mobile device 804 at a first MSISDN number issued by Mobile Operator A, but mobile device 804 has a second MSISDN number issued by Mobile Operator B. Mobile Operator A considers the call simply as a call along the first and second leg from mobile device 802 to the MIG 891. The VMN 899 is aware that the subscriber has two MSISDN numbers, and has obtained the HLR register information from each of Mobile Operator A and B. The VMN 899 supplies to MIG 890 the MSRN of mobile device 804, and the preferred IP route of MIG 891. At Mobile Operator B, the call appears as a local call from MIG 891 to mobile device 804, and the fourth and fifth legs are billed accordingly, without any need for Mobile Operators A and B to bill each other. The VMN has handled the third leg and the local number portability issue entirely. According to subscriber rules, the bill for the third leg and the services can be reported by the VMN to either the Mobile Operator A, the Mobile Operator B, or billed directly to the subscriber.

In each of the scenarios, overall costs are significantly reduced by eliminating the dedicated circuit leg 852. In the second scenario, further cost saving could be achieved for the subscriber, if the subscriber chose to use the IP phone device 803 instead of the mobile device 804 (as further discussed above). In the third scenario, each party is able to make substantial savings by treating the calls as local segments. Accordingly, billing for the first leg of the call gets billed back to Operator A and CDRs transmitted back to CDR Mediation Server 880 for processing to customer. Billing for the second leg of the call gets sent back to operator managing MIG 891 which may be either transit operator of transit IP server 899 or Operator B in this scenario.

Billing a call from IP softphone 801 to IP softphone 803, even where the call appear to the users to be between the associated MSISDN number of mobile devices 802 or 804 respectively, is handled entirely on the IP side. The VMN the Mobile Operators are only involved in the authentication, if authentication is somehow required. Technically, authentication would not be required in such a call, but practically and legally, the callers may require some assurance from the Mobile Operators that the MSISDNs have been used in association with the proper SIM.

Similarly, billing a call from either IP softphone to either mobile device will only involve the costs of transmission legs from the mobile device to the MSC, from the MSC to the MIG, and from the MIG along the SIP pathway to the IP softphone.

The method of the immediate invention creates a mechanism by which the difficulty of implementing a multitude of roaming agreements can be alleviated. An additional embodiment of the invention includes linking authentications between different GSM operators using MIG at each such operator and thereby avoiding the need for roaming agreements. An Alliance can be created where all existing GSM Operators would virtually roam (upon service activation by subscriber) to a platform sitting in the middle of the IP cloud transparent to the end user then it becomes one step closer to bridging the gap currently experienced by roaming agreements and settlements that could take months to execute and becomes very costly to maintain.

Routing between GSM operators pursuant to this additional embodiment improves call quality by reducing the number of routing legs involved, and by facilitating optimum routing. For example, if GSM operators in Countries A, B and C all employ the virtual roaming solution of the immediate invention with a common intermediate platform, or NGN operator that Country A utilizes, and Subscriber A has forwarded his E164 number in Country A to E164 number in Country B, then instead of the call going out to the PSTN network and carried over locally into Country B's network, it could be delivered directly to Country B's' network through the IP platform installed locally there through the SS7 interconnect. This ensures calling line identity (CLI) is completely preserved and quality is never degraded. The network server & soft switch combination (the VMN) that is sitting in the heart of the IP cloud and operated by a common virtual roaming partner, would automatically recognize that the subscriber has forwarded the E164 number from Country A to the E164 number to Country B. Since both E164 numbers reside on the same platform and database, it would be picked up immediately as a home call zone thus going out directly by IP all the way to the SS7 interconnect in Country B.

This results in more competitive costing. This technical solution requires one agreement with each GSM operator, rather than a web of agreements between each pair of operators, and for this reason is also a more practical solution to providing a global LNP database to contracting parties.

By implementing this methodology, operators can leverage the economics and prevalence of a homogenous telephony network whether it be GSM/IP/Wi-Fi.

1. A method for authenticating and connecting a softphone to a mobile telephone communications network, using an account associated with a mobile device registered to a mobile telephone communications operator providing service over the mobile telephone communications network, comprising the steps of:
(a) connecting the softphone to a smart card bearing a serial number associated with the account;
(b) connecting the softphone to an IP network,
(c) computer instructions causing the softphone to transmit the serial number and a current network location to a virtual mobile network (VMN) having an IP server and being connected to the IP network;
(d) the VMN storing the serial number and current network location in a virtual visitor location register (vVLR) and identifying the mobile telephone communications operator to which the account is registered based on the serial number;
(e) the VMN communicating authentication instructions compatible with the mobile telephone communications network via a mobile to internet gateway (MIG) having an internet protocol enabled server, an secondary protocol for translating communication between the IP network and an administration layer of the mobile telephone communications network, and a MIG address on the mobile telephone communications network;
(f) the MIG receiving an authorization record for the account from a home location register controlled by the mobile telephone communications operator and sending the authorization record to the VMN for storage in the virtual location register in association with the serial number;
(g) the VMN communicating either an authorization signal or a refusal to the softphone over the packet-switched network based on rules associated with the authorization record;
(h) where the authorization signal is to be communicated to the softphone, the VMN assigning a virtual roaming number and storing the virtual roaming number in the virtual location register in association with the serial number;
(i) notifying the home location register of the virtual roaming number and the MIG address;
(j) the home location register, in response to a request to connect a call destined for a dialable number associated with the serial number, providing the virtual roaming number and the MIG address.

2. The method of claim 1 wherein the virtual roaming number is assigned at the time of authorization and not in response to a call completion request

3. The method of claim 1 further comprising the steps of
(j) recording a call detail record (CDR) and a call event detail (CED) at the MIG; and
(k) transmitting the CDR and CED to a billing server controlled by the mobile telephone communications operator after the call is completed.

4. The method of claim 1 wherein the mobile telephone communications network is a GSM network.

5. The method of claim 5 further comprising steps between steps (e) and (f) of
i. receiving at the MIG a random number challenge for the smart card from an authentication center (AUC) of the GSM network;
ii. the MIG communicating the random number challenge to the softphone at the current network location; and
iii. the softphone causing the smart card to return a signature response (SRES) on the basis of the random number challenge and a Ki stored on the smart card and an implementation of the A3 algorithm;
wherein the communication between the MIG and the softphone is encrypted using IP based encryption to avoid the need for cipher key (Kc) based encryption.

6. The method of claim 1 wherein communication from the softphone is according to a voice over internet protocol from the group of voice over internet protocols consisting of session inititated protocol (SIP), H.323 and media gateway control protocol (MGCP).

7. The method of claim 5 wherein the communication of the random number challenge does not involve the VMN.

8. The method of claim 1 wherein communication between the VMN and the MIG is performed over a pathway from the group of pathways consisting of: direct connection between VMN and the MIG, IP connection between the VMN and the MIG, or a processor level connection where the VMN is installed as a component of the MIG.

9. A system for authorizing a softphone over a GSM mobile telephone communications network operated by a home operator, and for connecting and billing calls between the GSM network and the softphone, the system comprising:
(a) a virtual mobile network (VMN) having
i. a VMN internet protocol server to receive, process and store packet-switched data from the softphone, and
ii. an emulation of a visitor location register (vVLR) to store a softphone location record,
(b) a mobile to internet gateway (MIG) having
i. a voice over IP session initiated protocol (SIP) to signaling system number seven (SS7) gateway (SIP-SS7 server), and
ii. a MIG internet protocol server to receive and translate GSM instructions between a mobile switching centre (MSC) and a home location register (HLR) of the home operator from an SS7 channel and the VMN from the IP network,
(c) an emulation of a GSM mobile switching centre (vMSC) resident on the MIG and the VMN, and
(d) a first computer implemented rule on the VMN to effect the following authorization protocol:
i. receive an authorization request from the softphone, the authorization request containing a serial number from a SIM associated with the mobile account at a home operator;
ii. store at least part of the authorization request in the softphone location record;
iii. determine the HLR from the serial number;
iv. communicate a GSM roaming authorization request to the HLR via the MIG;
v. receive and store a reply signal containing either an authorization record or a refusal from the HLR via the MIG at the vVLR;
vi. a decision to allow the softphone request if the reply signal contains the authorization record with a permission for roaming; and

10. The system of claim 9, wherein the first software implemented rule further comprises the step (vii) of assigning a virtual roaming number (vMSRN) to the softphone and storing it in the softphone location record for mapping to an IP address of the softphone.

11. The system of claim 9 further comprising
(a) a second computer implemented rule on the MIG to:
i. receive a random number challenge for a smart card associated with the softphone from an authentication center (AUC) of the home operator;
ii. communicate the random number challenge to the softphone at a current network location; and
iii. receive a signature response (SRES) from the softphone and return the SRES to the AUC.

12. The system of claim 9 wherein communication from the softphone is according to voice over internet protocols from the group of voice over internet protocols consisting of session initiated protocol (SIP), H.323 and media gateway control protocol (MGCP).

13. The system of claim 11 wherein the communication of the random number challenge does not involve the VMN.

14. The system of claim 9 wherein the VMN further comprising a billing database and functionality to receive and store call detail records (CDRs) and to communicate CDRs to the home operator.

15. The system of claim 14 further comprising functionality to route calls to a VoIP gateway of a roaming operator and to receive CDRs from the roaming operator.

16. A global local number portability system for use between GSM operators over a packet-switched network comprising:
(a) an IP server having an IP address;
(b) computer implemented instructions within the IP server to emulate commands and responses of a home location register (vHLR);
(c) computer implemented instructions within the IP server to emulate commands and responses of a visitor location register (vVLR);
(d) a local number portability database containing mappings between a set of possible subscriber location numbers, a set of active subscriber location numbers and a set of subscriber access numbers, on one or more GSM networks;
(e) computer implemented instruction to receive authorization requests for a subscriber as the vHLR, to refer such requests to an actual HLR as a vVLR, and to respond to the original requester as the vHLR; and
(f) computer implemented instructions to receive call termination requests to a subscriber from a gateway mobile switching centre (G-MSC) as the vVLR and to respond with a with a virtual location register number representing a most preferred active location.

17. The global local number portability system of claim 12 further comprising at least one mobile to internet gateway (MIG) on an SS7 pipe of each GSM operator party to the system.

18. The global local number portability system of claim 17 wherein each MIG further comprises:
(a) a voice over IP session initiated protocol (SIP) to signaling system number seven (SS7) gateway (SIP-SS7 server), and
(b) an internet protocol server to receive and translate GSM instructions between a mobile switching centre (MSC) and a home location register (HLR) of the home operator from an SS7 channel and the VMN from the IP network.

19. The global local number portability system of claim 18 further comprising a billing database and functionality to receive and store call detail records (CDRs) and to communicate CDRs to the home operator.

20. The global local number portability system of claim 19 further comprising functionality to route calls to a MIG of a roaming operator and to receive CDRs from the roaming operator.

21. A combination mobile to internet gateway virtual mobile network device for authorizing a softphone over a GSM mobile telephone communications network operated by a home operator and for connecting calls between the GSM network and the softphone, the device comprising:
(a) a voice over IP session initiated protocol (SIP) to signaling system number seven (SS7) gateway (SIP-SS7 server) to route voice and data traffic to the softphone,
(b) an internet protocol server to receive, process and store packet-switched data from the softphone,
(c) an emulation of a visitor location register (vVLR) to store a softphone location record,
(d) an emulation of a GSM mobile switching centre (vMSC), and
(e) a first computer implemented rule to effect the following authorization protocol:
i. receive an authorization request from the softphone, the authorization request containing a serial number from a SIM associated with the mobile account at a home operator;
ii. store at least part of the authorization request in the softphone location record;
iii. determine the HLR from the serial number;
iv. communicate a GSM roaming authorization request to the HLR;
v. receive and store a reply signal containing either an authorization record or a refusal from the HLR in the vVLR; and
vi. a decision to allow the softphone request if the reply signal contains the authorization record with a permission for roaming.

22. The device of claim 21, wherein the first software implemented rule further comprises the step (vii) of assigning a virtual roaming number (vMSRN) to the softphone and storing it in the softphone location record for mapping to an IP address of the softphone.

23. The device of claim 21 further comprising
(a) a second computer implemented rule to:
i. receive a random number challenge for a smart card associated with the softphone from an authentication center (AUC) of the home operator;
ii. communicate the random number challenge to the softphone at a current network location; and
iii. receive a signature response (SRES) from the softphone and return the SRES to the AUC.

24. The device of claim 23 wherein the communication of the random number challenge does not involve the VMN.

25. The device of claim 21 wherein the serial number is an IMSI.

26. The device of claim 21 wherein the serial number is a combination of a PUK and a MSISDN.

27. The device of claim 21 further comprising a billing database and functionality to receive and store call detail records (CDRs) and to communicate CDRs to the home operator.

28. The device of claim 27 further comprising functionality to route calls to a VoIP gateway of a roaming operator and to receive CDRs from the roaming operator.
